(19) United States
(12) Patent Application Publication
(10) Pub. No.: US 2005/0078187 A1
(43) Pub. Date: Apr. 14, 2005

(54) Combination of response adapting filter and detector

(76) Inventors: Henrik Fabricius, Soborg (DK); Jan H. Hansen, Lyngby (DK); Jens Jorgen Jensen, Charlottenlund (DK); Hans Ole Nielsen, Lyngby (DK)

Correspondence Address: PITNEY HARDIN LLP, 7 TIMES SQUARE, NEW YORK, NY, 10036-7311, US

(21) Appl. No.: 10/481,304

(22) PCT Filed: Jun. 19, 2002
(86) PCT No.: PCT/DK02/00414

(30) Foreign Application Priority Data
Jun. 20, 2001 (DK) PA 2001 00960

(51) Int. Cl. H04N 17/00

(52) U.S. Cl. 348/187; 348/188

(57) ABSTRACT

A combination of a response adapting filter (11, 12, 13) and a detector (14), the detector having a predetermined spectral response function to electromagnetic radiation, a method of its preparation, a camera (11, 12, 13, 14, 15) comprising such a response filter and detector combination, and use thereof in e.g. colour measurements in combination with an integrating cavity and a vision inspection system of natural and/or a synthetic material surfaces; also a display and detector combination, a method of displaying optical information, a colour display and monitor system, and a method of controlling colour display, said combination, systems and methods comprising such combination of a response adapting filter and a detector.

### 1. BACKGROUND OF THE INVENTION

The present invention relates to combination of a response adapting filter and a detector, the detector having a predetermined spectral response function to electromagnetic radiation; a method of is preparation, a camera comprising such a response filter and detector combination, and use thereof in e.g. colour measurements in combination with an integrating cavity and a vision inspection system of natural and/or a synthetic material surfaces; also a display and detector combination, a method of displaying optical information, a colour display and monitor system, and a method of controlling colour display, said combination, systems and methods comprising such combination of a response adapting filter and a detector.

The Technical Field

Basics for Colour Measurements

The standard 2° calorimetric observer was defined by CIE in 1931 through the colour matching functions \overline{x}(λ),\overline{y}(λ) and \overline{z}(λ). See CIE publication No 15, COLORIMETRY Official recommendation of the international commission on illumination, 1971. The tristimulus values, X, Y and Z, of a given colour stimulus of a light source S(λ) are defined and calculated or measured as:

$$\begin{matrix}X = k \times {\int }_{λ 1}^{λ 2} ϕ ( λ ) \times \overline{x} ( λ ) ⅆ λ & ( 1 ) \\ Y = k \times {\int }_{λ 1}^{λ 2} ϕ ( λ ) \times \overline{y} ( λ ) ⅆ λ & ( 2 ) \\ Z = k \times {\int }_{λ 1}^{λ 2} ϕ ( λ ) \times \overline{z} ( λ ) ⅆ λ & ( 3 )\end{matrix}$$

wherein k is a factor for normalizing the light source, S(λ) defined as:

$$k = \frac{100}{{\int }_{λ 1}^{λ 2} S ( λ ) \times \overline{y} ( λ ) ⅆ λ} \qquad ( 4 )$$

and wherein φ(λ) is the colour stimulus in question defined as either following formulas 5a, 5b and 5c:
φ(α)=S(λ)×ρ(λ) (5a)
φ(λ)=S(λ)×β(λ) (5b)
φ(α)=S(λ)×τ(λ) (5c)
wherein
ρ(λ) is used when the colour stimulus in question concerns reflectance of a sample,
β(λ) is used when the colour stimulus in question concerns luminance factor of a sample
τ(λ) is used when the colour stimulus in question concerns transmittance of a sample.

For the above-given definitions of k in formula (4), Y defines the reflectance, the luminance factor, or the transmittance, expressed in percentage.

If the colour stimuli is direct light from the light source then φ(λ)=S(λ) (and if given in Watts) and k=683 lumen×W⁻¹, then the Y-stimulus value is the luminous flux from the light source.

The chromatic coordinates x,y are calculated from the tristimulus values as:

$$[ \begin{matrix}x \\ y\end{matrix} ] = [ \begin{matrix}\frac{X}{X + Y + Z} \\ \frac{Y}{X + Y + Z}\end{matrix} ] \qquad ( 6 )$$

Hence, for a given light source S(λ), the colour is unambiguously given by the chromatic co-ordinates (x,y) and Y. Other chromatic coordinates and colour differences defined by CIE as well as defined by others can also be derived from the tristimulus values X, Y and Z, of the CIE recommendations, ibid.

Colour Measurements

The function φ(λ) can be measured with a colour measuring system comprising a simple sensor, a scanning monochromator and a suitable light source and the tristimulus values X, Y and Z can be derived according to formulas (1), (2) and (3) and tabulated values of \overline{x}(λ), \overline{y}(λ) and \overline{z}(λ).

Most spectroradiometers utilizes this principle, although with substantially modified equipment. Preferably an imaging sensor like a CCD or a CMOS array photo detector is used as the sensor.

Alternatively, a grating, a linear CCD, or an array of photodiodes can be used to simultaneously measure φ(λ).

Measurements with spectroradiometers and uniform illumination can by calibration to a known sample be made independent of the light source used. Consequently, such measurements can be converted to a result for any given light source provided that the object measured is uniformly illuminated during the measurement.

Some spectroradiometers uses a number of LED's with dominant wavelengths throughout the spectrum instead of a ‘white’ light source and a monochromator. Such spectroradiometers work fine on non-fluorescent objects.

A simple calorimeter comprises a X-filter, a Y-filter and a Z-filter in combination with an imaging device and a sensor, each of said X, Y, Z-filters realizing one of the colour-matching functions \overline{x}(λ), \overline{y}(λ) and \overline{z}(λ). Known filters comprise a stack of colour filters, a mosaic of filter segments, and a template with a grating.

Only stacked colour filters in combination with an imaging sensor exhibit imaging properties.

The filters can be positioned in the colour measuring system to either shape the light source or shape the incoming light. Both methods are used in various applications. In many cases, because sensors are small and light sources in many cases are relatively large, the filters are positioned to shape the incoming light in front of the sensor.

Measurements with prior art filter calorimeters must be performed with a given light source the result of which, however, cannot unambiguously be converted from this one light source to another, even if proper uniform illumination has been used.

Prior art filter colorimeters suffers from either poor match to the colour-matching functions or low transmittance in case of the stacked type filter.

Stacked type filters can be made imaging, however they suffer a limited accuracy, and they require very expensive detectors such as cooled CCD's in order to operate under the inherently low transmittance of these filters. Mosaic- and template-type filters cannot be made imaging. Consequently, there is a need for colour measuring systems comprising colour-matching filters and detector combinations which allow imaging and which does not require expensive sensitive and cooled detectors.

Many attempts have been made to establish colour-measuring systems and devices, including calibration procedures therefore.

Colour cameras comprising 3 CCD detectors where the incoming light is split into 3 components of red, green and blue light have been suggested. However, shades of these three colours cannot be distinguished from a change in luminance because only one channel responds to the shades. Colour-measuring systems and devices based on such light splitting function cannot perform repeatable and traceable colour measurements according to the standards set by CIE.

Illumination and Geometry in Colour Measurements

Standard geometry's are defined for measuring reflectance and/or transmittance of an object, cf. CIE publication No 38 ‘Radiometric and photometric characteristics of materials and their measurement’, 1977. The standard geometries are 0°/45°, 0°/diffuse and 0°/total. The 0° measurements are performed in integrating spheres thereby obtaining uniform and diffuse illumination, and simultaneously excluding exterior light. The diffused light is obtained by including a light trap for the specular component.

According to Helmholtz reversal principle, the direction of illumination and observation can be reversed. Prior art measurements set-ups are well described in G. Wyszecki, “COLOR SCIENCE Concepts and Methods, Quantitative Data and Formulae”, 1982, in 3.3.7 “Standard Illuminating and viewing conditions” and in 3.12.3 “Spectrometers”.

Calibration of Calorimeters

For filter colorimeters comprising filters exhibiting given colour matching functions that are not identically with the CIE colour matching functions, the tristimulus values X′, Y′ and Z′ are found for a given colour stimulus. The colorimeter response might be improved in a more or less limited region of the colour space by introducing a 3×3-correction matrix M_{correction} as defined in formula (7). This matrix is found by measuring, at least 3, known samples, and then solving a set of equations to find the correction matrix.

$$[ \begin{matrix}\begin{matrix}X \\ Y\end{matrix} \\ Z\end{matrix} ] = {M}_{correction} \times [ \begin{matrix}\begin{matrix}{X}^{′} \\ {Y}^{′}\end{matrix} \\ {Z}^{′}\end{matrix} ] \qquad ( 7 )$$

In the extreme case, the response of special samples, monochromatic radiation can be measured for many given wavelengths, and a correction matrix can be found by minimizing with respect to some suitable error metrics, e.g. the f′₁ defined in the following section.

Calculation of f′₁ Errors for Detectors with Specified Spectral Responsivity

In CIE publication No 53, “Methods of characterising the performance of radiometers and photometers”, 1982, metrics are given for integrated photometer errors.

This error metrics concerns only the relative response. The output from radiometers and photometers must be corrected for linearity and dark current according to well-known procedures.

$$\begin{matrix}{f}_{1}^{′} = \frac{{\int }_{λ 1}^{λ 2} \vert {{S}_{χ} ( λ )}_{rel} - {{S}_{T} ( λ )}_{rel} \vert ⅆ λ}{{\int }_{λ 1}^{λ 2} {{S}_{T} ( λ )}_{rel} ⅆ λ} wherein & ( 8 ) \\ {{S}_{χ} ( λ )}_{rel} = \frac{{\int }_{λ 1}^{λ 2} {S ( λ )}_{A} \times {{S}_{T} ( λ )}_{rel} ⅆ λ}{{\int }_{λ 1}^{λ 2} {S ( λ )}_{A} \times {( λ )}_{rel} ⅆ λ} & ( 9 )\end{matrix}$$

and
S_{T}(λ)ᵣₑₗ: Specified relative responsivity
S(λ)ᵣₑₗ: Relative photometer responsivity
S(λ)_{A}: Relative spectral distribution of CIE standard Illuminant A

In the case of a calorimeter, 3 separate detectors are used; one for each colour-matching function, and hence 3 f′₁ errors are obtained.

Prior Art Disclosures

G. Wyszecki, “COLOR SCIENCE Concepts and Methods, Quantitative Data and Formulae”, 1982, 3.12.5 “Tri-stimulus-Filter Colorimeters”, describes the different types of calorimeters, including the template type, the stacked filter type, and the mosaic filter type. The template type and mosaic filter type can be very accurate but cannot be imaging. The stacked filter type can be accurate but with the expense of very small transmittance and therefore only useful with very sensitive sensors e.g. cooled CCD or photo multipliers.

U.S. Pat. No. 5,850,472 “Colorimetric imaging system for measuring color and appearance” discloses an imaging calorimeter based on a colour video camera with RGB response. In the “real world” the transform from RGB to XYZ colours in CIE space is not possible.

### 2. DISCLOSURE OF THE INVENTION

Object of the Invention

It is an object of the present invention to seek to provide an improved colour measuring system, in particular a tristimulus camera.

It is another object of the present invention to seek to provide a colour measuring system with improved transmittance.

It is another object of the present invention to seek to provide a colour measuring system comprising colour-matching filters and detector combinations which allow imaging and which does not require expensive sensitive and cooled detectors.

Further objects appear from the description elsewhere.

Solution According to the Invention

“Combination of Response Adapting Filter and Detector”

In an aspect according to the present invention, there is provided a combination of a response adapting filter and a detector, the detector having a predetermined spectral response function D(λ) to electromagnetic radiation; the response adapting filter comprising:
one or more optical multilayered structures of thin films on a substrate, said optical multilayer structures comprising two or more layers of thin film materials, said thin film materials comprising dielectric materials, metallic materials, or a combination thereof; and
said layers of thin films being adapted to provide a spectral transmittance T(λ) so that the spectral response D(λ)T(λ) of the detector matches a predetermined spectral-matching function y(λ).

It has surprisingly turned out that a very high transmittance is achieved whereby it is obtained that a colour measuring system comprising colour matching filters and detector combinations that allow imaging and which does not require expensive sensitive and cooled detectors can be provided.

Preferred embodiments are defined in the dependent claims 2-6.

“Method of Preparing a Response Adapting Filter and Detector Combination”

In another aspect according to the present invention there is provided a method of preparing a response adapting filter and detector combination, the method comprising:
providing a detector, said detector having a pre-determined spectral response function D(λ);
providing a substrate;
providing an optical multilayered structure on said substrate; said optical multilayered structure comprising two or more layers of thin film materials, said thin film materials comprising dielectric materials, metallic materials, or a combination thereof;
said optical multilayered structure of thin films being adapted to provide a spectral transmittance T(λ) according to an aspect of the invention for a combination of a response adapting filter comprising said optical multilayered structure of thin films and a detector;
said two or more layers of thin film materials being provided by deposition of said thin film materials by reactive gas deposition, and
said deposition being controlled by optical measurements;
whereby it is obtained that a colour measuring system comprising colour-matching filters and detector combinations which allow imaging and which does not require expensive sensitive and cooled detectors can be provided.

Preferred embodiments are defined in the dependent claims 8-11.

“Camera”

In still another aspect according to the present invention, there is provided a camera, the camera comprising:
an aperture means adapted to control radiant power from an object; p1 one or more response adapting filters according to an aspect of the invention, or obtainable by the method according to another aspect of the invention;
an imaging means adapted to generate an image of said radiant power of said object; said imaging means having an imaging spectral transmittance L(λ) and being positioned so that said one or more response adapting filters lie in the object space thereof, and
one or more energy collecting and detecting means adapted to collect and detect radiant power in discrete points of said image, said energy collecting means having an image collecting spectral response D(λ) which is substantially similar for all said discrete points of said image, said one or more response adapting filter being positioned in the object space of said imaging means;
whereby it is obtained that a colour measuring system, in particular a tristimulus camera, comprising colour-matching filters and detector combinations which allow imaging and which does not require expensive sensitive and cooled detectors can be provided.

Preferred embodiments are defined in the dependent claims 13-19.

“Camera Applications”

In still a further aspect according to the present invention, there is provided use of a camera according to the present invention. Preferred uses are defined in claims 20-24.

In a preferred embodiment a camera according to the invention is used in combination with an integrating cavity.

In another preferred embodiment a camera according to the invention is used in colour measurement in a vision inspection system.

In another preferred embodiment a camera according to the invention is used in colour measurement of a surface of natural and/or a synthetic material, wherein said natural surface is selected from the group consisting of a surface of a biological material including human and animal tissue and skin; and plants tissue including wood, and wherein said synthetic natural surface is selected from the group consisting of a surface of a material of textile, concrete, and paint.

“Display and Detector Combination”

In another aspect according to the present invention, there is provided a display and detector combination, said combination comprising:
a combination of a response adapting filter and a detector according to the invention, said combination producing a detector signal in response to electro-magnetic radiation; and
a display means, said display means comprising light emitting means to emit light in response to said detector signal, whereby optical information, e.g. tristimulus values of colour measurements can be displayed, e.g. on a video display unit, whereby an optimized reproduction of the object/scene can be obtained on said display means.

Preferred embodiments are defined in claims 26-29.

“Method of Displaying Optical Information”

In another aspect according to the present invention, there is provided a method of displaying optical information, said method comprising:
producing a detector signal in response to electro-magnetic radiation, said detector signal being produced by a combination of a response adapting filter and a detector according to an aspect the present invention; and
producing a display on a display means, said display means comprising light emitting means emitting light in response to said detector signal.

Preferred embodiments are defined in claims 31-32.

“Colour Display and Monitor System”

In another aspect according to the present invention, there is provided a colour display and monitor system, said display and monitor system comprising:
a colour display means, said colour display means comprising light-emitting means to emit coloured light in response to a display control signal; and
a monitor means, said monitor means comprising a combination of a response adapting filter and a detector as defined in an aspect of the present invention, said monitor means producing a monitor signal in response to said emitted light of said colour display means, whereby a colour display means displaying optical information, e.g. screen of in a video display system displaying a colour, or an image, can be monitored with a detector having a predetermined spectral detector response and provide a monitor signal which can be used to adjust the display control signal of the colour display. In this way colour information of e.g. a screen of video display unit, a projector screen, or a print produced by a printer, can be monitored and the display control signal can be adjusted to provide a desired display, e.g. correcting the displayed colour, intensity, etc.

It is intended that the term “light-emitting means to emit coloured light” include a colour light source, e.g. a phosphorous material emitting coloured light, or e.g. a diffusor emitting transmitted or reflected light, or fluorescence light.

Also, it is intended that the term “a display control signal” includes control signal for any suitable display means, e.g. control signals for an electronic monitor screen device, or e.g. control signals for a colour printer, said control signals optionally triggering further control signals of said means and devices.

Preferred embodiments are defined in claims 34-41.

In a preferred embodiment, said system further comprising signal storage means, said signal storage means storing at least one reference display control signal whereby it is obtained that a reference point for the display can be established.

In a preferred embodiment, said at least one reference display control signal is derived from a detector signal generated by a display and detector combination as defined in an aspect of the invention whereby e.g. electronic information of a colour display provided by a detector having a predetermined spectral detector response can be obtained.

In another preferred embodiment, said at least one reference display control signal is derived from said monitor signal whereby e.g. a reference point and a possible drift therefrom by the displayed colour display can be monitored.

In a preferred embodiment, said system further comprising a signal comparator means for comparing said monitor signal and said at least one reference display control signal, said signal comparator means producing a comparator control signal in response thereto whereby e.g. a possible drift from a reference point can be established.

Generally, a comparator control signal can be used for various applications, e.g. providing a feedback to illumination means for a corrected illumination of an object being measured.

In a preferred embodiment said system further comprising a control means for adjusting said display control signal, said control means adjusting said display control signal in response to said comparator control signal whereby the display can adjusted to a predetermined spectral detector response of the monitor and matching a predetermined spectral-matching function, e.g. that of a CIE standard calorimetric observer.

In a preferred embodiment, said display control signal, said monitor signal, said at least one reference display control signal, or a combination thereof, comprises an electronic tristimulus signal, in particular that of a CIE standard calorimetric observer.

The display means can be any suitable display means for displaying optical colour information.

In a preferred embodiment, said display means comprises a display means such as an electronic display screen, preferably a video display unit; a projector screen system, or an electronic printer, preferably a colour printer.

Generally, connection between said colour display means and monitor means include any suitable signal connecting means known to a skilled person.

In a preferred embodiment, colour display and monitor system further comprises a connection means for connecting said monitor signal to a display and detector combination as defined in an aspect of the invention, in particular a display means such as an electronic display screen, preferably a video display unit; a projector screen system, or an electronic printer, preferably a colour printer.

“Method of Controlling a Colour Display”

In another aspect according to the present invention, there is provided a method of controlling a colour display, said method comprising:
displaying a colour on a display means, said display means comprising light emitting means to emit coloured light in response to a display control signal;
monitoring said display means by a monitor means comprising a combination of a response adapting filter and a detector as defined in an aspect of the present invention, said monitor means producing a monitor signal in response to said emitted light of said display means;
comparing said at least one reference control signal and said monitor signal by comparator means for comparing said at least one reference control signal and said monitor signal, said comparator means producing a comparator control signal in response thereto; and
adjusting said display control signal by a control means for adjusting said display control signal, said control means adjusting said display control signal to produce an adjusted response of said emitted coloured light on said display means.

In a preferred embodiment, said display control signal, said monitor signal, said at least one reference display control signal, or a combination thereof, comprises an electronic tristimulus signal whereby in particular an optimized reproduction of a scene on said display means can be obtained.

It should be noted however that the term “light-emitting means to emit coloured light” is intended to have a broad meaning, including a colour light source, e.g. a phosphorous material emitting coloured light, or e.g. a diffusor emitting transmitted or reflected light, or fluorescence light. However, the term is also intended to include e.g. a colour print the colour of which may be controlled by adjusting the printer producing such a colour print by a signal derived from said monitor signal.

### 3. BRIEF DESCRIPTION OF THE DRAWINGS

In the following, by way of examples only, the invention is further disclosed with detailed description of preferred embodiments. Reference is made to the drawings in which

FIG. 1 shows an embodiment of the present invention illustrating a tristimulus filter-type imaging camera according to the invention, where the three filters are mounted in a filter-wheel or filter sledge and images are detected by one array detector;

FIG. 2 shows an alternative embodiment of a tristimulus filter-type imaging camera in which three separate channels each having it own array detector are used;

FIGS. 3 and 4 show alternative embodiments of the present invention shown in FIG. 1 and FIG. 2;

FIGS. 5A and 5B show alternative embodiments of an optical multilayer structure of thin films for a colorimeter and tristimulus camera with high transmittance;

FIG. 6 illustrates the response folding operation for achieving filter characteristics of CIE colour-matching functions;

FIG. 7 shows a tristimulus filter design by both stacking and side-by-side placement of coloured filters for colorimeters of the non-imaging type;

FIG. 8 shows a template for the template type colorimeter of the non-imaging type according to prior art;

FIG. 9 shows a pixel layout on a CCD chip used for colour photography with one CCD according to prior art;

FIG. 10 shows a layout used for colour photography with 3 CCD cameras according to prior art;

FIG. 11 shows a spectral response of RGB type CCD cameras according to prior art as used in FIG. 9 and 10;

FIG. 12 shows a tristimulus filter design comprising a stack of coloured filters for calorimeters and tri-stimulus cameras with very low transmittance and medium match;

FIG. 13 shows a detailed illustration of an embodiment of a camera comprising of a front lens group, next to the filters, spacing with an aperture and a rear lens group next to the image collecting means;

FIG. 14 shows measured system responses of an embodiment of a camera compared with CIE responses;

FIG. 15 shows a cross-sectional sketch of an integrating cavity to be used in combination with a camera according to the invention (not shown);

FIG. 16 shows an embodiment of a camera recording an image of a scene, and storing one or more signals representing said image;

FIG. 17 shows an embodiment of a display and detector combination, here a camera recording and storing an image as shown in FIG. 16, and displaying said image, optionally said stored image, on a display;

FIG. 18 shows an embodiment of a colour display and monitor system for monitoring a colour display and optionally correcting, or calibrating said displayed colour display; and

FIG. 19A and 19B show an embodiment of a colour display and monitor system incorporated in a display and detector combination as shown in FIG. 17.

### 4. DETAILED DESCRIPTION

FIG. 1 shows an embodiment of the present invention illustrating a tristimulus filter-type imaging camera according to the invention, where the three filters are mounted in a filter-wheel or filter sledge and images are detected by one array detector.

A tristimulus image is recorded, as three separate images, by an image collecting and detecting means 14, here a photo detector array, through an imaging means 15, here a lens or lens system, and through three filters 11, 12 and 13, one for each separate image, where the three filters are mounted in a filter-wheel or filter sledge.

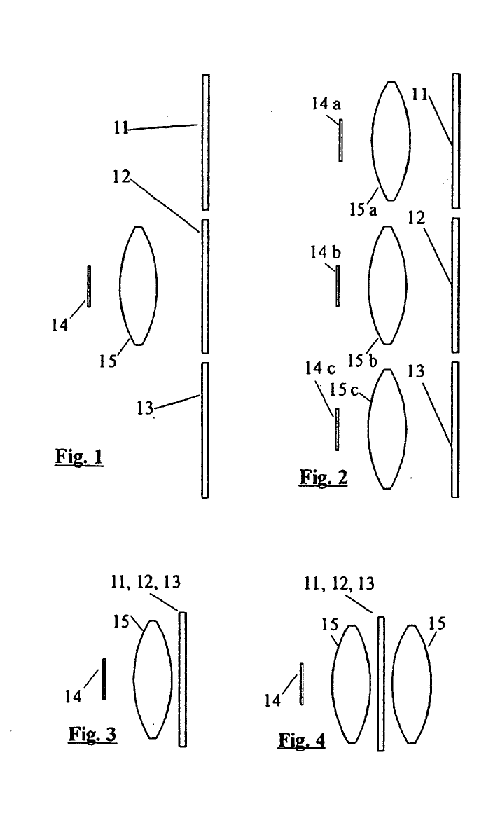

FIG. 2 shows an alternative embodiment of a tristimulus filter-type imaging camera in which three separate channels each having it own array detector are used. The embodiment shows three image collecting and detecting means 14a, 14b and 14c, here three CCD array photo-detectors; three imaging means 15a, 15b and 15c, here illustrated by three lenses; and each channel having one of the three filters 11, 12 and 13, here optical multilayered structures of thin films. This system can provide three simultaneously images.

In FIGS. 3, 4, and 5 are shown alternative arrangements of filter and imaging system.

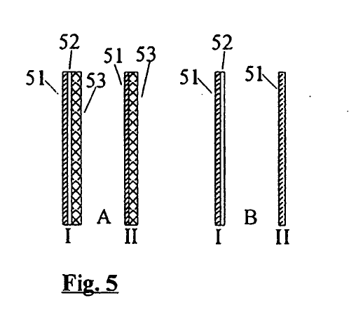

FIGS. 3 and 4 show alternative embodiments of the present invention shown in FIG. 1 and FIG. 2.

FIGS. 5A and 5B show alternative embodiments of an optical multilayer structure of thin films for a calorimeter and tristimulus camera with high transmittance.

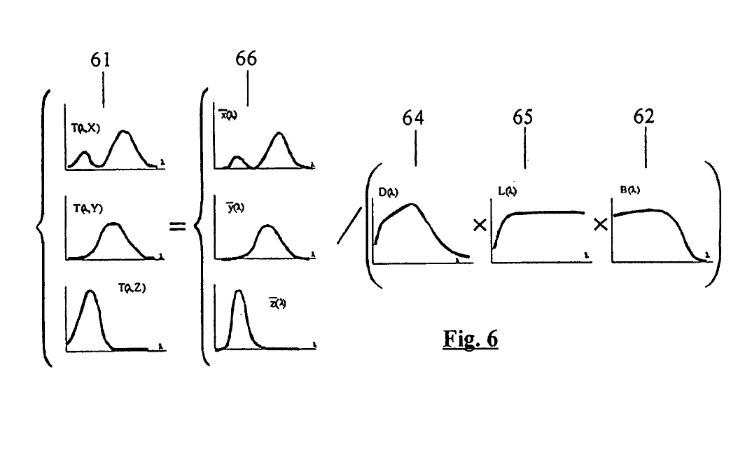

FIG. 6 illustrates the response folding operation for achieving filter characteristics of CIE colour-matching functions.

The total spectral system response is given by the CIE colour matching functions \overline{x} (λ), \overline{y} (λ) and \overline{z} (λ) 61. The response of the filters is hence given by the residual spectral response as found by a folding procedure illustrated in FIG. 6; the transmittance of the imaging system L(λ) being found as 65, and the response of the image collector D(λ) being found as 64.

A computer and suitable software can control the whole process and present the result as images on a video display unit (VDU) or as digital files.

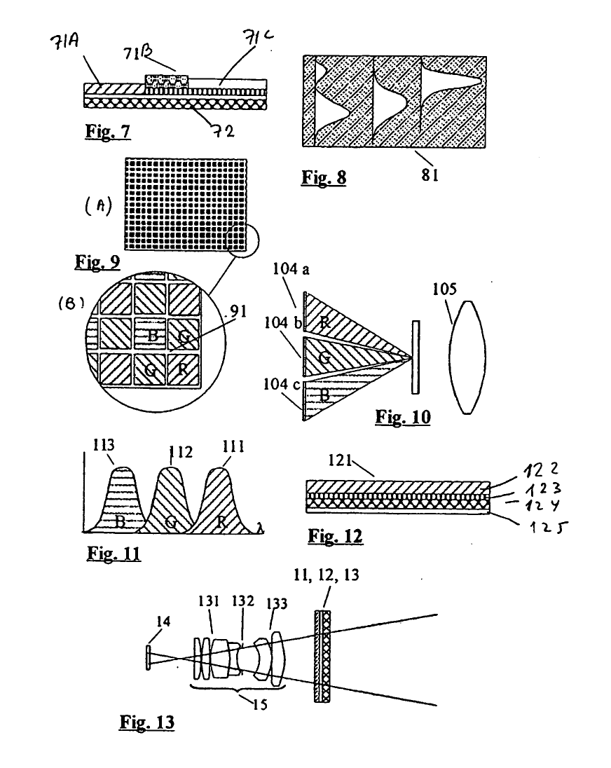

FIG. 7 shows a tristimulus filter design by both stacking and side-by-side placement of coloured filters 71A, 71B, 71C on a substrate 72 for calorimeters of the non-imaging type.

FIG. 8 shows a template for the template type calorimeter of the non-imaging type according to prior art; said template having indicated on top thereof the individual response functions.

FIG. 9 shows a pixel layout on a CCD chip used for colour photography with one CCD according to prior art. FIG. 9(B) shows an enlarged section of the lower right corner of the CCD chip shown in FIG. 9(A).

FIG. 10 shows a layout used for colour photography with 3 CCD cameras according to prior art. The lens 105 and the beamsplitter 106 splits the light into three components R, G, and B each detected by its colour detector 104a, 104b, and 104c.

FIG. 11 shows a spectral response 111, 112, 113 of RGB type CCD cameras according to prior art as used in FIG. 9 and 10.

FIG. 12 shows a tristimulus filter design comprising a stack of coloured filters 112, 123, 124, and 125 for calorimeters and tristimulus cameras with very low transmittance and medium match.

FIG. 13 shows a detailed illustration of an embodiment of a camera comprising of a front lens group 133, next to the filters, spacing with an aperture 132 and a rear lens group 131 next to the image collecting means.

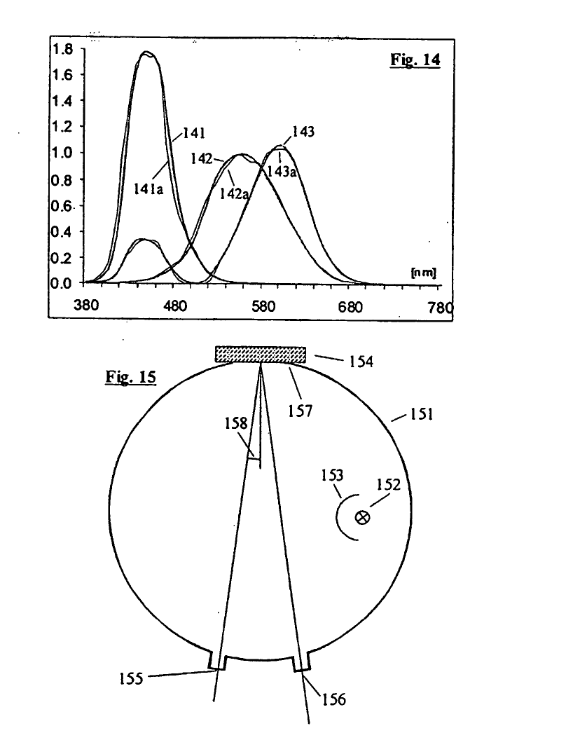

FIG. 14 shows measured system responses of an embodiment of a camera compared with CIE responses. \overline{x}(λ), \overline{y}(λ) and \overline{z}(λ) defined by CIE are labelled 141, 142 and 143. \overline{x}(λ), \overline{y}(λ) and \overline{z}(λ) realised by an embodiment of the camera is labelled 141a, 142a and 143a

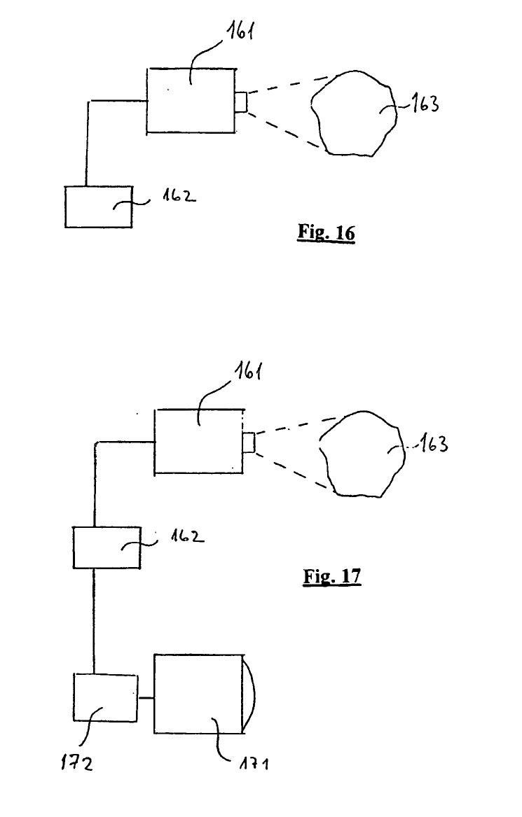

FIG. 15 shows a cross-sectional sketch of an integrating cavity to be used in combination with a camera according to the invention (not shown). More details are given in the examples.

FIG. 16 shows an embodiment of a camera 161 recording an image of a scene 163, and storing one or more signals representing said image in a memory 162.

The detector signals representing an image recorded by a camera according to an aspect of the invention can be obtained by means known to a skilled person. In an embodiment CCD array signals are stored in a solid-state memory, or other storage device, e.g. a DVD, CD, etc.

FIG. 17 shows an embodiment of a display 171, 172 and detector 161 combination, here a camera 161 recording and storing 162 an image 163 as shown in FIG. 16, and displaying said image, optionally said stored image, on a display 171 including suitable signal processing means 172, e.g. realized in a microprocessor or dedicated analog or digital electronic circuit.

Means for displaying said recorded and stored image representation, including signal processing, are known in the art, e.g. comprising display means such as an electronic display screen, preferably a video display unit; a projector screen system, or an electronic printer, preferably a colour printer.

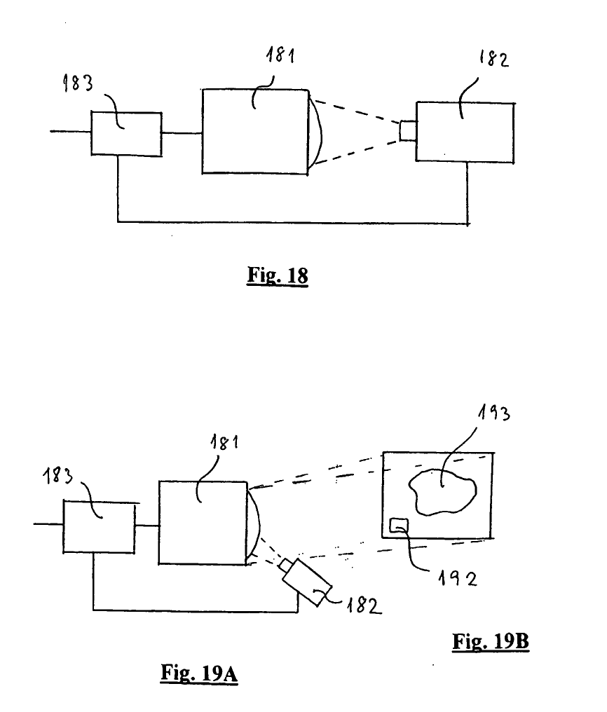

FIG. 18 shows an embodiment of a colour display 181 and a monitor system 182 for monitoring a colour display, here a calibration target on a monitor screen, or the whole screen as such, and optionally correcting, or calibrating, said colour display by suitable comparator and signal correction means 183. The monitor 182 on-line monitors the screen of the display 181 unit, said screen showing e.g. an image, and optionally showing a separate calibration target. A comperator and correction unit 183 providing adjustment of display control signals for the display 181 unit in response to said monitor control signal, whereby an optimized display, optionally corrected for drift, can be obtained.

Suitable comparator and signal correction means are known in the art, including analog and digital signal comparators, e.g. realized in a microprocessor or dedicated analog or digital electronic circuit.

FIG. 19A shows an embodiment of a colour display 181 and monitor 182 system incorporated in a display and detector combination as shown in FIG. 17 for on-line calibration of a display, e.g. a whole screen or a part thereof as shown in FIG. 19B.

The monitor 182 on-line monitors a calibration target 192 on a screen of the display 181 unit, said screen further showing an image 193. A comperator and correction unit 183 providing adjustment of display control signals for the display 181 unit in response to said monitor control signal, whereby an optimized display, optionally corrected for drift, can be obtained.

Preparation of Response Adapting Filters

According to the invention said one or more response matching filters 11, 12, and 13 of the filter camera are adapted to modify the spectral information of the radiant power from the object so that the total response of the camera matches a predetermined colour-matching function (x(λ)).

In a preferred embodiment a response adapting is prepared according to a method comprising:
providing a substrate, here exemplified by a transparent substrate in form of a plate such as a glass plate, e.g. BG38 or BG39;
coating the substrate with an anti-reflecting coating, here exemplified by a material such as SiO₂; in a particular embodiment said anti-reflecting coating comprises silica deposited on directly on said substrate, e.g. in form of a glass plate; for certain applications an anti-reflection coating is not required on the substrate;
coating an optical multilayer structure, here a dielectric thin film structure having a predetermined transmittance function T(λ); said predetermined transmittance function being determined by dividing the desired total response function of the camera, here exemplified by the \overline{x}(λ), \overline{y}(λ), and \overline{z}(λ) according to the CIE standard observer, with the spectral response function of all filter components except that of the thin film structure, the detector response and response of the imaging system; said coating being applied according to e.g. the technique of Sullivan et al., the major steps of which is outlined in below;
applying one or more block filters onto said optical multilayer structure, here exemplified by an absorption filter for cutting off undesired light of wavelengths above an upper limit, e.g. IR light above about 780 nm, and/or an absorption filter for cutting off light having wavelength below a certain lower limit, e.g. UV light below about 350 nm; and
applying one or more neutral density filters onto said one or more block filters for attenuating the intensity of the radiant power at all wavelengths.

Preparation of response adapting filters can be carried out in any way suitable for achieving the desired functions for their individual application.

Examples of use of response adapting filters RA generally include configurations: D-L-RA-A-O-S, wherein D is an image collecting and detecting means, L is an imaging means, RA is a response adapting filter, A is an aperture which can be positioned elsewhere in the system, e.g. D-A-L-RA-O-S, D-L-A-RA-A-O-S, O is an object and S is a light source.

The response-adapting filter RA can generally include structures of thin films of different order, e.g. substrate-AR-T-BG-ND, subtrate-T-BG-BG, substrate-T, wherein AR is an anti-reflex coating, BG is a blocking filter, and ND is a neutral density filter.

Preparation of Optical Multilayer Structures of Thin Films

An optical multilayer structure to be applied in a response-adapting filter and detector combination of the present invention can be prepared by any suitable method that allows preparation of a controlled optical thin film structure.

Techniques include multilayer deposition techniques such as sputtering, evaporation, reactive ion-plating evaporation, and chemical vapor deposition.

Suitable thin film preparation techniques are disclosed by Sullivan et al., see e.g. “Deposition of Optical Multilayer Coatings with Automatic Error Compensation. I. Theoretical Description”, Applied Optics, Vol. 31, 3821-3835, 1992, and “Deposition Error Compensation for Optical Multilayer Coatings. II. Experimental Results—Sputtering System”, Applied Optics, Vol. 32, No. 13, 2351-2360, the content of which is incorporated herein by reference, the latter specifically including an automated magnetron-sputtering system.

U.S. Pat. No. 6,217,720, published Apr. 17, 2001 discloses a multi-layer reactive sputtering method with reduced stabilization time for depositing a complex multilayer coating on a substrate, said coating consisting of at least two materials. Optical measurements are taken of deposited layers and compared with model values to continually control and insurances of homogeneity of the deposited layers and allowance of valid thickness determination from said model. It is shown that complex filters have been fabricated.

The system comprises:
(A) a deposition system comprising a sputtering chamber, cryo pump, Magnetrons, etc; more details are disclosed in U.S. Pat. No. 6,217,720, published Apr. 17, 2001, incorporated herein by reference,
(B) a process control system comprising a computer controlling chamber pressure, oxygen flow and power for the magnetrons,
(C) a monitoring system comprising a light source and a grating and PDA array for retrieving spectral information, and
(D) a deposition control system comprising a computer controlling the monitoring system and software for calculating layer thickness and a possibly re-optimising of the next layer thickness

The system is operated in a deposition sequence comprising:
(A) transfer of the multilayer design and the desired optical performance of the coating;
(B) selection of process-control parameters;
(C) loading of substrate in deposition chamber, including transmittance measurement of the substrate;
(D) establish communication between process control system and deposition system.; and
(E) initiating automated deposition mode;

For each layer the following steps are performed:
(A) spectral transmission is measured and compared to the predicted transmission;
(B) the refractive index and optical thickness of the previous layer are estimated;
(C) the thin-film design of the non-deposited layers is re-optimised to take into account the actual performance of the deposited layers in the coating;
(D) the addition of further layers is performed as long as the deviation between the obtained and the desired spectral transmission exceeds a predefined level;
(E) the coating machine is prepared for the deposition of the next layer, if further layers are needed. This layer is named the present layer in the following;
(F) the desired optical thickness of the present layer is estimated on basis of a re-optimisation of the theoretical design;
(G) the main part of the desired thickness is deposited. However, the layer is terminated sufficiently early that the thickness not is too large;
(H) the spectral transmission is measured and compared to the predicted transmission;
(I) the refractive index and optical thickness of the present layer are estimated by comparison of the measured transmission values and the theoretical model;
(J) the optical thickness of the remaining part of the present layer is recalculated on basis of the revised spectral data;
(K) the deposition of the layer is finished at a reduced speed to minimize the error in the final thickness of the layer;
(L) steps O to Q are repeated until a sufficient layer thickness is obtained.

### 5. EXAMPLES

Preferred embodiments of the invention are illustrated by examples of preparation of a response-adapting filter.

Preparation of Response-Adapting Filter

Preparation of a response-adapting filter 61, here exemplified by preparation of X, Y, and Z filters for a CIE tristimulus camera, is illustrated in FIG. 6.

The step of realising the transmittance functions T(λ,X), T(λ,Y), T(λ,Z) of the optical multilayered structure of thin films comprises:
providing a predetermined spectral-matching function 66, generally indicated by x(λ), y(λ), z(λ), here the colour-matching functions \overline{x}(λ), \overline{y}(λ) and \overline{z}(λ);
measuring the spectral response function 64 of the detector, here a common detector response D(λ) for each filter, excluding the response of the response adapting filters;
measuring the spectral response function 65 of the imaging means, here a common detector response for each filter L(λ), excluding the response of the response adapting filters;
measuring the spectral response function 62 of the auxiliary means 62, here a response function for a lens system 15 e.g. the lens groups 131, 132, 133 shown in FIG. 13, excluding the response of the response adapting filters;
measuring the spectral response function 62 of further auxiliary means 62, here e.g. a response function for blocking filter for blocking in g.e. The IR or/and UV region of the spectrum, excluding the response of the response adapting filters;
measuring the spectral response function 62 of further auxiliary means 62, here e.g. a response function for neutral density filter, excluding the response of the response adapting filters;
generally, using the same procedure for any other auxiliary filters, e.g. an anti-reflex filter; or substrates, including substrates carrying said optical multilayered structure of thin films; and
combining the individual responses to provide the residual response in the transmittance functions of the optical multilayered structure of thin films to match the desired response of the response adapting filter.

Alternatively, the transmittance functions T(λ,X), T(λ,Y), T(λ,Z) may be derived from any suitable combination of the combined elements of the filter, excluding the response of the response adapting filters, and then add the residual response in the transmittance functions of the optical multilayered structure of thin films to match the desired response of the response adapting filter.

The preferred embodiment of the filters is shown in FIG. 5. The alternatives AI and AII are for X and Y filter, while the BI and BII are for the Z filter. The layer 51 illustrates a blue glass absorption-type filter for blocking infrared radiation. The used types for the X and Y filters are BG39 from Schott Glaswerke. For the Z filter is used a BG38, also from Schott Glaswerke. The layer 52 illustrates a glass substrate like BK7 from Schott Glaswerke. The layer 53 illustrates a neutral density filter, either a ND25, Hoya for the Y filter or a ND40, Hoya for the X filter.

The neutral density filter types are chosen so that the total system response in the X, Y and Z channels is close to even for the three channels when exposed either to direct tungsten light or direct daylight. This gives the advantages that the three exposures can be performed without changing anything in the camera settings, and thereby reducing time between exposures, give the same conditions for the three channels and a good signal to noise ratio.

Even for a camera with three channels, each channel comprising a neutral density filter, it can be an advantages to exclude the ND filters, e.g. in order to provide desired sensitivities.

For type-I-filters with substrates 52 there is a minimum of waste of expensive BG glass types. The substrates are first AR coated, which is a simple process compared to the next coating process, the response adapting coating. Then the substrates are cemented to the BG glass and optionally the ND glass. If the coating processes did not succeed then only the simple substrate was wasted. This type I has though the advantages that the thin film always is cemented against another glass and thereby protected from the moisture in the environment.

It can be difficult to cement three filters together without introducing errors in alignment. This problem is gone when the type II filters are used, where the coatings are performed directly on the BG type glass.

This type II filters do expose the thin film to the environment, and therefore this type should only be used for very dense coatings, resistible against moisture or in closed systems protected against variation in humidity.

Thin film coatings show a spectral dependency on the angle of incidence. Therefore, in this embodiment of the inventions, the response adapting filters are placed in front of the lens, and further the lens is selected so that the angle of view is restricted to ±10°. Further the response adapting filters are optimised to an angle of incidence of ±3°, hereby minimizing the overall error.

Due to tolerances in all the components, a deviation from the perfect system response must be expected. Therefore the image collecting system, typically comprising a PC with suitable software, can introduce a correction procedure in form of correction matrices as mentioned for formula (7). If necessary different corrections matrices can be implemented for the different part of the image, depending on the angle in the viewing field.

The chromatic coordinates, calculated according the formula (6) is independent of the absolute level of light. To introduce absolute measurements, of luminance or Y from formula (2), the iris aperture 132, see FIG. 13, of the lens must be replaced by an aperture comprising a hole of well-known diameter. A collection of holes can be realized on a wheel, and shifted in between the front 133 and rear 131 lens group, according to light level. Further, the focus distance, and shutter speed, must be known, but with a motor driven focus system, with feedback this is simply realized. With an embodiment as here mentioned, the tristimulus camera can be absolute calibrated to luminance and colour measurements.

Preferred embodiments of the invention are further illustrated by examples of production of a camera including a B/W video camera from SONY (XCD-X700) as image collectors, and the front and rear lens group of an objective supplied from Schneider Kreuznach (Xenoplan 1,4/23) as imaging system. A hole aperture wheel or sledge for controlling the light level on the above-mentioned video camera was provided by means known to the skilled person.

Further, three response-adapting filters according to the invention were provided at outlined above, and mounted in a filter wheel or sledge placed in front of the objective for holding and shifting the filters.

Colour Measurements

As preparation for colour measurements, the tristimulus camera is exposed to complete darkness and an image (an average of say 100 image) is recorded, as the ‘dark image’ so the dark noise pattern is known. Then the camera is exposed to a known scene, preferable a uniform illuminated surface. An image (an average of say 100 image) through one of the filters is recorded as the ‘white image’.

A colour measurement is then performed by taking one dark image, calculating the current dark level, scale the previous dark image to the current dark level and hereby produce the current absolute dark noise pattern.

Then the X filter is shifted in front of the lens and first one image is taken to remove so called lag. Then a number, one ore more by choice, of images are averaged and the current absolute dark noise pattern is subtracted (pixel by pixel). The result is multiplied by the reciprocal white image (pixel by pixel). Same procedure is followed to obtain the Y and Z images.

A matrix, and a factor for scaling the images to absolute values (luminance) then correct the images.

Images can be recorded of scenes with controlled lighting conditions. A preferred embodiment is shown in FIG. 15.

Most calibration laboratories for measuring the reflection properties of materials use this set up. The integrating sphere 151 provides both indirect and diffuse light and a shield from unwanted light. The light is provided by light sources 152 inside the sphere or light transported into the sphere by example light guides. The latter has the advantages of reducing heat problems.

A shield 153 prevents the target and the camera from receiving direct light. The target 154 is placed against an opening 157 in the sphere. The camera is measuring through another opening 155. Preferably the measurement is done at an angle 158 towards the target, different from 0°, to avoid reflections between the camera and the target. If the port 156 is closed the measurement is with the specular component included, and if the port is open an equipped with a light trap, the measurement is without the specular component.

These integrating spheres are purchased from Porschke or LMT, both Germany.

This set up is normally used to measure homogeneity of targets with non-imaging spectroradiometers. Samples with colour textures can be measured with the camera and the characteristics of the texture can be measured and calculated. Examples are textiles and all kind of granular materials.

As the camera is measuring colour as the human eye, the camera is very suitable for sorting material like marble and wood, production control etc.

Further this camera has potential in automatic screening of medical samples and growth in titre plates, telemedicine etc.

1. A combination of a response adapting filter and a detector, the detector having a predetermined spectral response function (D(λ)) to electromagnetic radiation; the response adapting filter comprising:
one or more optical multilayered structures of thin films on a substrate, said optical multilayer structures comprising two or more layers of thin film materials, said thin film materials comprising dielectric materials, metallic materials, or a combination thereof; and
said layers of thin films being adapted to provide a spectral transmittance (T(λ)) so that the spectral response (D(λ)T(λ)) of the detector matches a predetermined spectral-matching function (y(λ)).

2. The combination according to claim 1 comprising one or more auxiliary filters, said auxiliary filters each having a spectral transmittance (B(λ)) of said electromagnetic radiation;
said layers of thin films being adapted to provide a spectral transmittance (T(λ)) so that said spectral response (D(λ)T(λ)B(λ)) of the detector, including said spectral transmittances of said auxiliary filters, matches said predetermined spectral-matching function (y(λ)).

3. The combination according to claim 2 wherein said one or more auxiliary filters comprises filters selected from the group consisting of:
one or more layers of anti-reflecting coating; said anti-reflecting coating having a spectral transmittance (B(λ)=AR(λ)) attenuating one or more reflections regions of the spectrum of said electromagnetic irradiation;
one or more blocking filters, said blocking filters having a spectral transmittance (B(λ)=BG(λ)) attenuating one or more regions of the spectrum of said electromagnetic radiation; and
one or more neutral density filters; said neutral density filters having a spectral transmittance (B(λ)=ND(λ)) attenuating the whole spectrum of said electromagnetic radiation.

4. The combination according to any of claims 1-3 wherein said predetermined spectral-matching function is a standardized response function.

5. The combination according to claim 1 wherein said predetermined spectral-matching function is a colour-matching function (x(λ), y(λ) and z(λ)) of the CIE 1931 standard colorimetric observer.

6. The combination according to claim 1 wherein said predetermined spectral-matching function is a standardized action response function defined by CIE, preferably an euretheine-matching function, a photo-synthesis-matching function, and a billirubin-matching function.

7. A method of preparing a response adapting filter and detector combination, the method comprising:
providing a detector, said detector having a predetermined spectral response function (D(λ))
providing a substrate;
providing an optical multilayered structure on said substrate; said optical multilayered structure comprising two or more layers of thin film materials, said thin film materials comprising dielectric materials, metallic materials, or a combination thereof;
said optical multilayered structure being adapted to 20 provide a spectral transmittance (T(λ)) as defined in claim 1;
said two or more layers of thin film materials being provided by deposition of said thin film materials by reactive gas deposition, and
said deposition being controlled by optical measurements.

8. The method according to claim 7 wherein said reactive gas deposition of said thin film materials comprises reactive ion sputtering, ion beam sputtering, reactive ion platting, reactive ion-assisted deposition, and chemical vapour deposition, and a combination thereof.

9. The method according to claim 7 or 8 wherein said adaptation of said optical multilayered structure include said layers of thin films being adapted to provide a spectral transmittance (T(λ)) so that the spectral response (D(λ)T(λ)) of the detector matches a predetermined spectral-matching function (y(λ)) within a predetermined fitness error f₁, said fitness error f₁ being less than 30%, preferably less than 15%, most preferred less than 5%, in particular less than 3%.

10. The method according to claim 7 wherein said thin film materials comprises materials providing hard metal oxides.

11. The method according to claim 7 wherein said hard metal oxides are selected from the group consisting of oxides of Ti, Hf, Zr, Si, Ta, Al and Y, preferably Ti0₂, Hf0₂, Zr0₂, Si0₂, Ta₂0₅, and Y₂0₃, Al₂0₃ most preferred Ti0₂ and Si0₂.

12. A camera, the camera comprising:
an aperture means adapted to control radiant power from an object;
one or more response adapting filters as defined in claim 1, or obtainable by the method as defined in claim 7;
an imaging means adapted to generate an image of said radiant power of said object; said imaging means having an imaging spectral transmittance (L(λ)) and being positioned so that said one or more response adapting filters lie in the object space thereof, and
one or more energy collecting and detecting means adapted to collect and detect radiant power in discrete points of said image, said energy collecting means having an image collecting spectral response (D(λ)) which is substantially similar for all said discrete points of said image, said one or more response adapting filter being positioned in the object space of said imaging means.

13. The camera according to claim 12 wherein said one or more image collecting and detecting means comprises an array of monochromatic detectors.

14. The camera according to claim 12 or 13 comprising three response adapting filters (X,Y,Z) for each of the tristimulus colour-matching functions x(λ), y(λ) and z(λ) of the CIE 1931 standard calorimetric observer (either 2° or 10°).

15. The camera according to claim 12 wherein said one or more response adapting filter are positioned in the object space of said imaging means within a threshold view angle thereof, said threshold angle being less than ±15 degrees, preferably less than ±10 degrees; in particular in the range of ±5 to ±10 degrees.

16. The camera according to claim 12 wherein said imaging means comprises an objective, said objective being adapted to provide a maximum view angle of less than ±15 degrees.

17. The camera according to claim 12 wherein transmission of the three filters are adjusted so that the imaging device can operate with constant aperture and constant integration time and still utilise the full dynamic range of the imaging device.

18. The camera according to claim 12 wherein said image collecting means comprises an array of photo-detectors.

19. The camera according to claim 12 wherein said aperture means comprises a movable aperture, including an aperture wheel having one or more apertures of predefined aperture openings.

20. (canceled)

21. (canceled)

22. (canceled)

23. (canceled)

24. (canceled)

25. A display and detector combination, said combination comprising:
a combination of a response adapting filter and a detector as defined in claim 1, said combination producing a detector signal in response to electromagnetic radiation; and
a display means, said display means comprising light emitting means to emit light in response to said detector signal.

26. The combination according to claim 25 wherein said a combination of a response adapting filter and a detector as defined in claim 1 is incorporated in a camera as defined in claim 12.

27. The combination according to claim 25 further comprising a storage means for storing said detector signals.

28. The combination according to claim 25 wherein said display means comprises an electronic display screen, a projector screen system, or an electronic printer.

29. The combination according to claim 28 wherein said projector screen system comprises a video display unit for emitting light in response to said detector signal.

30. A method of displaying optical information, said method comprising:
producing a detector signal in response to electromagnetic radiation, said detector signal being produced by a combination of a response adapting filter and a detector as defined in claim 1; and
producing a display on a display means, said display means comprising light emitting means emitting light in response to said detector signal.

31. A method according to claim 30 wherein said optical information is a colour.

32. A method according to claim 30 wherein said optical information is an image.

33. A colour display and monitor system, said display and monitor system comprising:
a display means, said display means comprising light emitting means to emit coloured light in response to a display control signal; and
a monitor means, said monitor means comprising a combination of a response adapting filter and a detector
as defined in claim 1, said monitor means producing a monitor signal in response to said emitted light of said display means.

34. The system according to claim 33, said system further comprising signal storage means, said signal storage means storing at least one reference display control signal.

35. The system according to claim 34 wherein said at least one reference display control signal is derived from a detector signal generated by a display and detector combination as defined in claims 25-29.

36. The system according to claim 33 wherein said at least one reference display control signal is derived from a said monitor signal.

37. The system according to claim 33, said system further comprising a signal comparator means for comparing said monitor signal and said at least one reference display control signal, said signal comparator means producing a comparator control signal in response thereto.

38. The system according to claim 33, said system further comprising a control means for adjusting said said display control signal, said control means adjusting said display control signal in response to said comparator control signal.

39. The system according to claim 33 wherein said display control signal, said monitor signal, said at least one reference display control signal, or a combination thereof, comprises an electronic tristimulus signal.

40. The system according to claim 33 wherein said display means comprises a display means as defined in claim 25.

41. The system according to claim 33 further comprising a connection means for connecting said monitor signal to a display and detector combination as defined in claim 25.

42. A method of controlling a colour display, said method comprising:
displaying a colour on a display means, said display means comprising light emitting means to emit coloured light in response to a display control signal;
monitoring said display means by a monitor means comprising a combination of a response adapting filter and a detector as defined in claim 1, said monitor means producing a monitor signal in response to said emitted light of said display means;
comparing said at least one reference control signal and said monitor signal by comparator means for comparing said at least one reference control signal and said monitor signal, said comparator means producing a comparator control signal in response thereto; and
adjusting said display control signal by a control means for adjusting said display control signal, said control means adjusting said display control signal to produce a an adjusted response of said emitted coloured light on said display means.

43. The method according to claim 42 wherein said display control signal, said monitor signal, said at least one reference display control signal, or a combination thereof, comprises an electronic tristimulus signal.

44. The camera according to claim 12, wherein said array of monochromatic detectors is an array of photo detectors.

45. The combination according to claim 25 wherein said electronic display screen is a video display unit.

46. The combination according to claim 25 wherein said electronic printer is a color printer.
